(19) United States
(12) Patent Application Publication
(10) Pub. No.: US 2022/0401995 A1
(43) Pub. Date: Dec. 22, 2022

(54) VIBRATION DEVICE WITH CONTROLLABLE FLUCTUATION HEIGHT

(71) Applicant: Shenzhen Yihejiahang Technology Co., Ltd., Shenzhen (CN)

(72) Inventors: Gang JIN, Shenzhen (CN); Wenxiang PAN, Shenzhen (CN)

(73) Assignee: Shenzhen Yihejiahang Technology Co., Ltd., Shenzhen (CN)

(21) Appl. No.: 17/489,847

(22) Filed: Sep. 30, 2021

(30) Foreign Application Priority Data
Jun. 21, 2021 (CN) 2021106866563

(51) Int. Cl. B06B 1/12

(52) U.S. Cl. CPC B06B 1/12

(57) ABSTRACT

A vibration device with a controllable undulation height is provided, comprising: a lower hood, and a motor is fixedly connected to a bottom of an inner cavity of the lower hood, and the inner cavity of the lower hood is provided with a vibration mechanism; the vibration mechanism comprises two support seats, and the two support seats are symmetrically distributed and fixedly connected to the lower hood, an inside of a support seat is provide with a synchronization connecting rod, and the synchronization connecting rod penetrates the support seat and is movably sleeved with the support seat, an end of the synchronization connecting rod is fixedly connected with an eccentric bearing, and a synchronization wheel is arranged outside the synchronization connecting rod, the synchronization wheel is arranged outside the synchronization connecting rod and is movably sleeved with the synchronization connecting rod, a belt is arranged outside the synchronization wheel.

### CROSS-REFERENCE TO RELATED APPLICATIONS

The application claims priority to Chinese patent application No. 202110686656.3, filed on Jun. 21, 2021, the entire contents of which are incorporated herein by reference.

### TECHNICAL FIELD

The present disclosure relates to the technical field of vibration devices, in particular to a vibration device with a controllable undulation height.

### BACKGROUND

The working part of the vibrator is a rod-shaped hollow cylinder with an eccentric vibrator inside, which rotates at a high speed driven by a motor and generates high-frequency micro amplitude vibration. The vibration frequency can reach 12000-15000 times/min, the vibration effect is good, the structure is simple, the service life is long, and the vibrator is suitable for vibrating beam, column, wall and other components and mass concrete.

The prior art has the following disadvantages: most of the lifting and lowering of the existing vibration devices adopt the lever principle to realize the undulating height. Because the principle of lever can only achieve one side lifting, the vibration devices need to set multiple levers to achieve the lifting of the inside of the vibration device. Thus, the structure is complicated and occupies more space inside the device. Therefore, it is necessary to develop a vibration device with a controllable undulation height. Therefore, it is necessary to develop a vibration device with a controllable undulation height.

### SUMMARY

For this purpose, present disclosure provides a vibration device with a controllable undulation height. The motor drives the rotation of the belt to drive the rotation of the synchronization wheel, thereby driving the rotation of the synchronization connecting rod, and the rotation of the synchronization connecting rod drives the rotation of the eccentric bearing. And the living hinge connection between the transmission shaft and the first and second connecting pieces, the first clamping piece and the second clamping piece, and the first lifting piece and the fourth lifting piece can effectively drive the second lifting piece and the up and down movement of the fourth lifting piece, and solve the problem that the existing vibration device needs to be provided with a plurality of levers device to realize the lifting and lowering of the vibration device, the structure is complicated and the space inside the device is relatively large.

In order to achieve the above object, the present disclosure provides the following technical solution: a vibration device with a controllable undulation height, comprising: a lower hood, a motor is fixedly connected to the bottom of the inner cavity of the lower hood, and a vibration mechanism is arranged in the inner cavity of the lower hood.

The vibration mechanism comprises two support seats, and the two support seats are symmetrically distributed and fixedly connected to the lower hood. The synchronization connecting rod is provided in the support seat, and the synchronization connecting rod penetrates the support seat and is movably sleeved with the support seat. An end of the synchronization connecting rod is fixedly connected with an eccentric bearing. A synchronization wheel is arranged outside the synchronization connecting rod, the synchronization wheel is arranged outside the synchronization connecting rod and is movably sleeved with the synchronization connecting rod. A belt is arranged outside the synchronization wheel, the belt is arranged on an outside of an output end of the motor and the synchronization wheel, and is respectively movably sleeved with the output end of the motor and movably sleeved with the synchronization wheel. The transmission shaft is arranged outside the synchronization connecting rod. The synchronization connecting rod penetrates an end of the transmission shaft and is movably sleeved with the transmission shaft, and both ends of the outside of the transmission shaft are provided with synchronization connection pieces, and the synchronization connection pieces are arranged on the outside of the synchronization connecting rod and movably sleeved with the synchronization connecting rod.

Preferably, an upper hood is arranged at a top of the lower hood, and the upper hood is arranged at the top of the lower hood and is movably sleeved with the lower hood.

Preferably, two supports are fixedly connected at four corners of the bottom of the inner cavity of the lower hood, the two supports are symmetrically distributed. The second connection piece is provided on a side of the support, a first connection piece is provided on a side of the second connection piece. The first connecting piece and the second connecting piece are disposed inside the two supports and are rotationally connected to the two supports.

Preferably, an end of the transmission shaft away from the eccentric bearing is arranged inside the first connecting piece and the second connecting piece and is movably hinged with the first connecting piece and the second connecting piece.

Preferably, the first clamping piece is provided on the side of the second connecting piece, the second clamping piece is provided on one side of the first clamping piece, the second clamping piece is arranged inside the first connecting piece and the second connecting piece, the first clamping piece and the second clamping piece are both movably hinged to the first connecting piece and the second connecting piece.

Preferably, the first lifting-lowering piece is provided inside the first clamping piece and the second clamping piece. And the first lifting-lowering piece is provided inside the first clamping piece and the second clamping piece and is movably hinged with the first clamping piece and the second clamping piece. And the second lifting-lowering piece is fixedly connected on a top of the first lifting-lowering piece.

Preferably, the inner cavity of the lower hood is provided with a third lifting-lowering piece on the side away from the first lifting-lowering piece. The third lifting-lowering piece is disposed inside the first clamping piece and the second clamping piece and is movably hinged with the first clamping piece and the second clamping piece. And the fourth lifting-lowering piece is fixedly connected to a top of the third lifting-lowering piece.

Preferably, a top of the four lifting-lowering piece and a top of a second lifting-lowering piece are fixedly connected to a bottom of an inner cavity of the upper hood.

Preferably, a number of transmission shafts is four, the transmission shafts are arranged at both ends of an outer side of the synchronization connecting rod, and the synchronization wheel is provided inside the two transmission shafts.

Preferably, four damping blocks are fixedly connected to a bottom of the lower hood, the four damping blocks are arranged at four corners of the bottom of the lower hood and are distributed in a circumferential array.

The beneficial effects of the present disclosure are:

1. The vibration device with the controllable undulation height of the present disclosure drives the belt to rotate through the motor, thereby driving the rotation of the synchronization connecting rod, and the rotation of the synchronization connecting rod drives the rotation of the eccentric bearing. And the living hinge connection between the transmission shaft and the first and second connecting pieces, the first clamping piece and the second clamping piece, and the first lifting piece and the fourth lifting piece can effectively drive the second lifting piece and the up and down movement of the fourth lifting piece, and solve the problem that the existing vibration device needs to be provided with a plurality of levers device to realize the lifting and lowering of the vibration device, the structure is complicated and the space inside the device is relatively large.

2. The present disclosure can effectively drive the upper hood to reciprocate up and down uniformly by setting a number of the transmission shafts as four and respectively located at the two ends of the inner cavity of the lower hood, and an end of the transmission shaft uniformly placed at the four corners. Through the connection between the upper hood and the second lifting-lowering piece and the fourth lifting-lowering piece, the synchronous vibration of the second lifting-lowering piece and the fourth lifting-lowering piece can be effectively realized, so that the vibration of the vibration device with the controllable undulation height can be realized.

### BRIEF DESCRIPTION OF DRAWINGS

FIG. 1 illustrates an overall structure diagram of the present disclosure;

FIG. 2 illustrates a schematic diagram of the internal structure of a lower hood of the present disclosure;

FIG. 3 illustrates an internal structure diagram of the present disclosure;

FIG. 4 illustrates a fourth lifting-lowering piece structure diagram of the present disclosure;

FIG. 5 illustrates a second lifting-lowering piece structure diagram of the present disclosure;

FIG. 6 illustrates an eccentric bearing structure diagram of the present disclosure.

### DETAILED DESCRIPTION OF THE EMBODIMENTS

The preferred embodiment of the present disclosure is described in the following illustration. It should be understood that the preferred embodiment described here is only used to explain and interpret the disclosure and is not used to qualify the present disclosure.

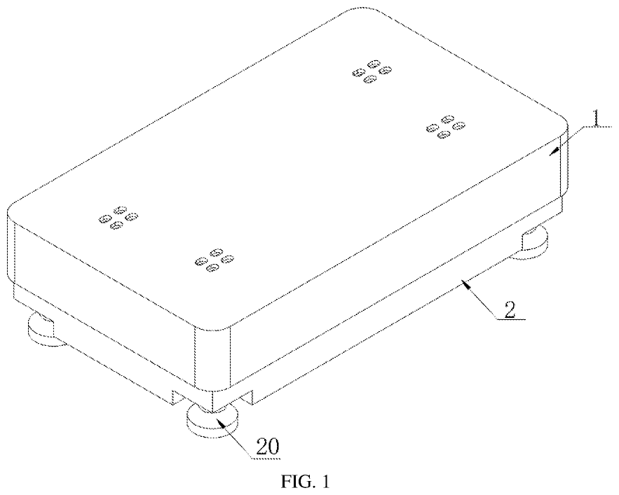

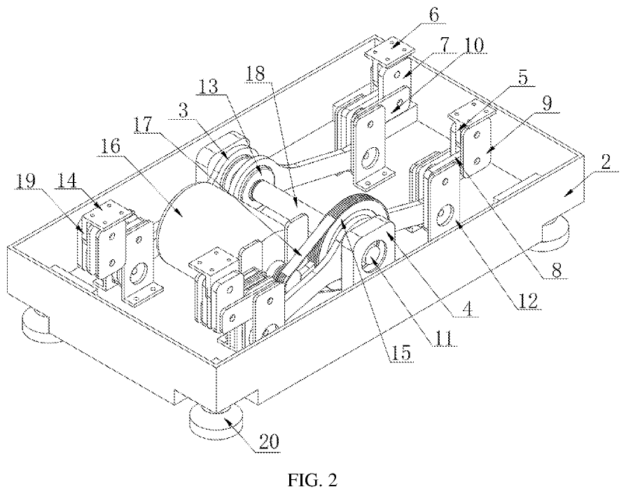

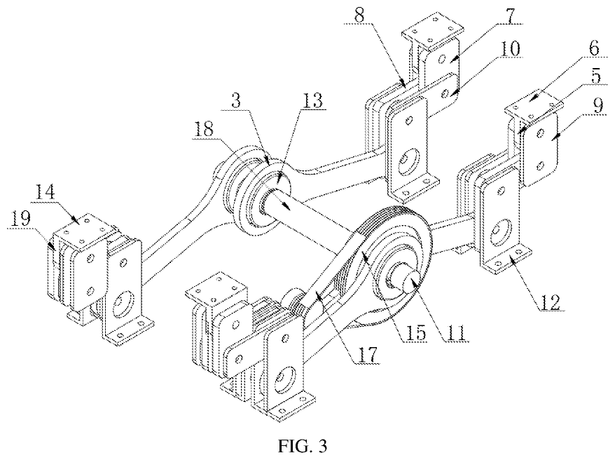

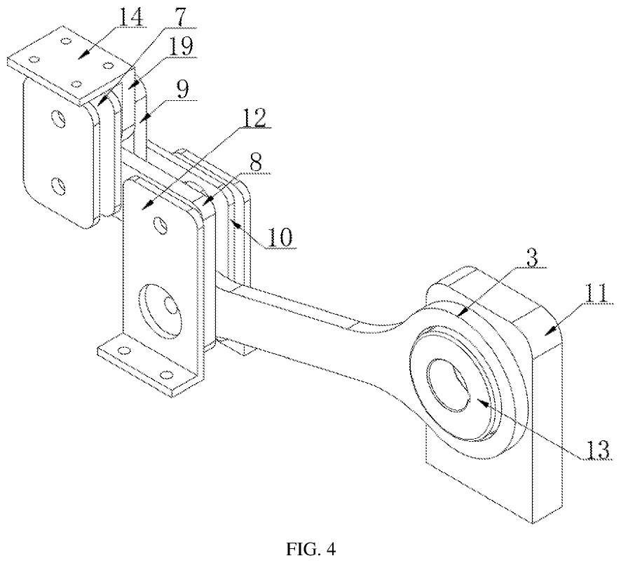

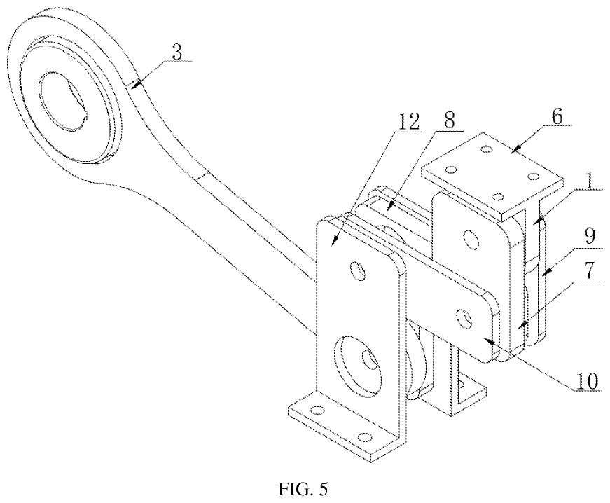

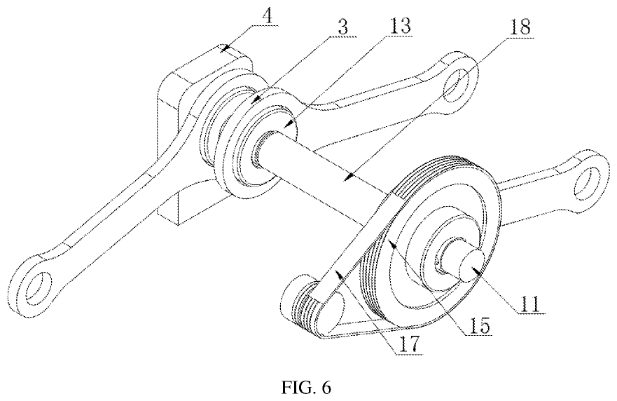

Referring to FIG. 1 to FIG. 6, a vibration device with a controllable undulation height is provided in the present disclosure, comprising: a lower hood 2, and a motor 16 is fixedly connected to a bottom of an inner cavity of the lower hood 2, and the inner cavity of the lower hood 2 is provided with a vibration mechanism;

the vibration mechanism comprises two support seats 4, and the two support seats 4 are symmetrically distributed and fixedly connected to the lower hood 2, an inside of a support seat 4 is provide with a synchronization connecting rod 11, and the synchronization connecting rod 11 penetrates the support seat 4 and is movably sleeved with the support seat 4, an end of the synchronization connecting rod 11 is fixedly connected with an eccentric bearing 18, and a synchronization wheel is arranged outside the synchronization connecting rod 11, the synchronization wheel is arranged outside the synchronization connecting rod 11 and is movably sleeved with the synchronization connecting rod 11, a belt 17 is arranged outside the synchronization wheel, the belt 17 is arranged on an outside of an output end of the motor 16 and the synchronization wheel, and is respectively movably sleeved with the output end of the motor 16 and movably sleeved with the synchronization wheel, a transmission shaft 3 is arranged outside the synchronization connecting rod 11, the synchronization connecting rod 11 penetrates an end of the transmission shaft 3 and is movably sleeved with the transmission shaft 3, synchronization connection pieces 13 are arranged at both ends of an outside of the transmission shaft 3, a synchronization connection piece 13 is provided outside the synchronization connecting rod 11 and is movably sleeved with the synchronization connecting rod 11. The synchronization wheel is driven to rotate by the movable sleeve between the belt 17 and the output end of the motor and the synchronization wheel, the synchronization connecting rod 11 is driven to rotate through the movable sleeve between the synchronization wheel and the synchronization connecting rod 11, and the eccentric bearing 18 is driven to rotate through the fixed connection between the synchronization connecting rod 11 and the eccentric bearing 18, so as to effectively drive the rotation of the transmission shaft 3;

further, an upper hood 1 is arranged at a top of the lower hood 2, and the upper hood 1 is arranged at the top of the lower hood 2 and is movably sleeved with the lower hood 2; through the movable sleeve between the upper hood 1 and the lower hood 2, and the fixed connection between the top of the fourth lifting-lowering piece 14 and the second lifting-lowering piece 6 and the upper hood 1, the fourth lifting-lowering piece 14 and the second lifting-lowering piece 6 can be effectively driven to vibrate synchronously, and then the upper hood 1 can be driven to reciprocate up and down;

further, two supports 12 are fixedly connected at four corners of the bottom of the inner cavity of the lower hood 2, the two supports 12 are symmetrically distributed, a second connection piece 8 is provided on a side of a support 12, a first connection piece 10 is provided on a side of the second connection piece 8, the first connecting piece 10 and the second connecting piece 8 are disposed inside the two supports 12 and are rotationally connected to the two supports 12. Through the rotating connection between the first connecting piece 10 and the second connecting piece 8, and the support 12, the transmission shaft 3 at both ends of the first connecting piece 10 and the second connecting piece 8 can be effectively driven, and the movable hinge between the first clamping piece 9 and the second clamping piece 7, and between the first connecting piece 10 and the second connecting piece 8 can be effectively driven. And then the second lifting-lowering piece 6 and the fourth lifting-lowering piece 14 can be driven to reciprocate up and down, so that the upper hood 1 can be driven to reciprocate up and down;

further, an end of the transmission shaft 3 away from the eccentric bearing 18 is disposed inside the first connecting piece and the second connecting piece and is movably hinged with the first connecting piece and the second connecting piece; the first connecting piece 10 and the other end of the second connecting piece can be effectively driven to move up and down through the movable hinge between the transmission shaft 3 and the first connecting piece and the second connecting piece;

further, a first clamping piece 9 is provided on the side of the second connecting piece 8, a second clamping piece 7 is provided on a side of the first clamping piece 9, the second clamping piece 7 is disposed inside the first connecting piece 10 and the second connecting piece 8, the first clamping piece 9 and the second clamping piece 7 are each movably hinged with the first connecting piece 10 and the second connecting piece 8, through the movable hinge between the first clamping piece 9 and the second clamping piece 7 and the first connecting piece 10 and the second connecting piece 8, the first clamping piece 9 and the second clamping piece 7 can be effectively driven to reciprocate up and down, and then the second lifting-lowering piece 6 and the fourth lifting-lowering piece 14 can be driven to reciprocate up and down;

further, a first lifting-lowering piece 5 is provided inside the first clamping piece 9 and the second clamping piece 7, the first lifting-lowering piece 5 is provided inside the first clamping piece 9 and the second clamping piece 7 and is movably hinged with the first clamping piece 9 and the second clamping piece 7, a second lifting-lowering piece 6 is fixedly connected to a top of the first lifting-lowering piece 5; through the movable hinge between the first lifting-lowering piece 5 and the first clamping piece 9 and the second clamping piece 7, the lifting and lowering of the first lifting-lowering piece 5 can be effectively driven, so that the second lifting-lowering piece 6 to reciprocate up and down;

further, the inner cavity of the lower hood 2 is provided with a third lifting-lowering piece 19 on a side away from the first lifting-lowering piece 5, the third lifting-lowering piece 19 is disposed inside the first clamping piece 9 and the second clamping piece 7 and is movably hinged with the first clamping piece 9 and the second clamping piece 7, a fourth lifting-lowering piece 14 is fixedly connected to a top of the third lifting-lowering piece 19, through the movable hinge between the third lifting-lowering piece 19 and the first clamping piece 9 and the second clamping piece 7, the lifting and lowering of the third lifting-lowering piece 19 can be effectively driven, thereby driving the fourth lifting-lowering piece 14 to reciprocate up and down;

further, a top of the four lifting-lowering piece and a top of a second lifting-lowering piece 6 are fixedly connected to a bottom of an inner cavity of the upper hood 1;

through the movable hinge between the second lifting-lowering piece 6 and the fourth lifting-lowering piece 14 and the first clamping piece 9 and the second clamping piece 7 and the fixed connection with the upper hood 1, the second lifting-lowering piece 6 and the fourth lifting-lowering piece 14 and the upper hood 1 can be effectively driven to reciprocate up and down, so as to realize the vibration of the present disclosure;

further, a number of transmission shafts 3 is four, the transmission shafts 3 are provided at both ends of an outer side of the synchronization connecting rod 11, and the synchronization wheel is provided inside the two transmission shafts 3, the number of the transmission shafts 3 is four and are respectively located at both ends of the inner cavity of the lower hood 2, through uniformly placing an end of the transmission shaft 3 at four corners, the upper hood 1 can be effectively driven to reciprocate up and down;

further, four damping blocks 20 are fixedly connected to a bottom of the lower hood 2, the four damping blocks 20 are arranged at four corners of the bottom of the lower hood 2 and are distributed in a circumferential array, through the arrangement of the damping blocks 20, the present disclosure can effectively damp the lower hood 2 during vibration.

The use process of the present disclosure is as follows: in using of the present disclosure, driving the belt 17 to rotate through the motor 16 by the user, and driving the synchronization wheel to rotate through the movable sleeve between the belt 17 and the output end of the motor and the synchronization wheel, driving the rotation of the synchronization connecting rod 11 by the movable sleeve between the synchronization wheel and the synchronization connecting rod 11, driving the rotation of the eccentric bearing 18 by the fixed connection between the synchronization connecting rod 11 and the eccentric bearing 18, thereby driving the rotation of the transmission shaft 3, through the movable hinge between an end of the transmission shaft 3 and the first connecting piece 10 and the second connecting piece 8, and the rotating connection between the first connecting piece 10 and the second connecting piece 8 and the support 12, driving the first connecting piece 10 and the second connecting piece 8 to move circumferentially; at the same time, through the movable hinge between the first connecting piece 10 and the second connecting piece 8 and the first clamping piece 9 and the second clamping piece 7, and the movable hinge between the first clamping piece 9 and the second clamping piece 7, the first lifting-lowering piece 5 and the third lifting-lowering piece 19, effectively driving the movement of the second lifting-lowering piece 6 and the fourth lifting-lowering piece 14; meanwhile, through the fixed connection between the top of the fourth lifting-lowering piece 14 and the second lifting-lowering piece 6 and the upper hood 1, effectively driving the fourth lifting-lowering piece 14 and the second lifting-lowering piece 6 to vibrate synchronously, and then driving the upper hood 1 to reciprocate up and down.

The above mentioned embodiment is only a preferred embodiment of the present disclosure, and any person skilled in the art may modify the present disclosure or modify it to the equivalent technical solution using the technical solution described above. Any modifications, equivalent changes, improvements, etc. made according to the scope of the present disclosure still belong to the protection scope of the present disclosure.

What is claimed is:

1. A vibration device with a controllable undulation height comprises a lower hood, wherein: a motor is fixedly connected to a bottom of an inner cavity of the lower hood, and the inner cavity of the lower hood is provided with a vibration mechanism;
the vibration mechanism comprises two support seats, and the two support seats are symmetrically distributed and fixedly connected to the lower hood, an inside of a support seat is provide with a synchronization connecting rod, and the synchronization connecting rod penetrates the support seat and is movably sleeved with the support seat, an end of the synchronization connecting rod is fixedly connected with an eccentric bearing, and a synchronization wheel is arranged outside the synchronization connecting rod, the synchronization wheel is arranged outside the synchronization connecting rod and is movably sleeved with the synchronization connecting rod, a belt is arranged outside the synchronization wheel, the belt is arranged on an outside of an output end of the motor and the synchronization wheel, and is respectively movably sleeved with the output end of the motor and movably sleeved with the synchronization wheel, a transmission shaft is arranged outside the synchronization connecting rod, the synchronization connecting rod penetrates an end of the transmission shaft and is movably sleeved with the transmission shaft, synchronization connection pieces are arranged at both ends of an outside of the transmission shaft, a synchronization connection piece is provided outside the synchronization connecting rod and is movably sleeved with the synchronization connecting rod.

2. The vibration device with the controllable undulation height according to claim 1, wherein: an upper hood is arranged at a top of the lower hood, and the upper hood is arranged at the top of the lower hood and is movably sleeved with the lower hood.

3. The vibration device with the controllable undulation height according to claim 2, wherein: two supports are fixedly connected at four corners of the bottom of the inner cavity of the lower hood, the two supports are symmetrically distributed, a second connection piece is provided on a side of a support, a first connection piece is provided on a side of the second connection piece, the first connecting piece and the second connecting piece are disposed inside the two supports and are rotationally connected to the two supports.

4. The vibration device with the controllable undulation height according to claim 3, wherein: an end of the transmission shaft away from the eccentric bearing is disposed inside the first connecting piece and the second connecting piece and is movably hinged with the first connecting piece and the second connecting piece.

5. The vibration device with the controllable undulation height according to claim 4, wherein: a first clamping piece is provided on the side of the second connecting piece, a second clamping piece is provided on a side of the first clamping piece, the second clamping piece is disposed inside the first connecting piece and the second connecting piece, the first clamping piece and the second clamping piece are each movably hinged with the first connecting piece and the second connecting piece.

6. The vibration device with the controllable undulation height according to claim 5, wherein: a first lifting-lowering piece is provided inside the first clamping piece and the second clamping piece, the first lifting-lowering piece is provided inside the first clamping piece and the second clamping piece and is movably hinged with the first clamping piece and the second clamping piece, a second lifting-lowering piece is fixedly connected to a top of the first lifting-lowering piece.

7. The vibration device with the controllable undulation height according to claim 6, wherein: the inner cavity of the lower hood is provided with a third lifting-lowering piece on a side away from the first lifting-lowering piece, the third lifting-lowering piece is disposed inside the first clamping piece and the second clamping piece and is movably hinged with the first clamping piece and the second clamping piece, a fourth lifting-lowering piece is fixedly connected to a top of the third lifting-lowering piece.

8. The vibration device with the controllable undulation height according to claim 7, wherein: a top of the four lifting-lowering piece and a top of a second lifting-lowering piece are fixedly connected to a bottom of an inner cavity of the upper hood.

9. The vibration device with the controllable undulation height according to claim 1, wherein: a number of transmission shafts is four, the transmission shafts are provided at both ends of an outer side of the synchronization connecting rod, and the synchronization wheel is provided inside the two transmission shafts.

10. The vibration device with the controllable undulation height according to claim 1, wherein: shock blocks are fixedly connected to a bottom of the lower hood, a number of the shock blocks is four, the four shock blocks are arranged at four corners of the bottom of the lower hood and are distributed in a circumferential array.
